(19) United States
(12) Patent Application Publication
(10) Pub. No.: US 2006/0194467 A1
(43) Pub. Date: Aug. 31, 2006

(54) Flexible power adaptor system and method

(76) Inventors: Nigel Beasley, Chesham (GB); Scott C. Smith, Phoenix, AZ (US)

Correspondence Address: MORRISON & FOERSTER LLP, 12531 HIGH BLUFF DRIVE, SUITE 100, SAN DIEGO, CA, 92130-2040, US

(21) Appl. No.: 11/328,525

(22) Filed: Jan. 10, 2006

Related U.S. Application Data
(60) Provisional application No. 60/642,859, filed on Jan. 10, 2005.

(51) Int. Cl. H01R 13/625

(52) U.S. Cl. 439/339

(57) ABSTRACT

A multiple outlet power product, includes a main body having a first power connector, a power cord having first and second ends, the first end attached to the main body and electrically connected to the first power connector, a power plug attached to the second end of the power cord and configured to receive power from a power source, and a circuit breaker disposed in the main body. In one embodiment, the first power connector is shaped so as to directly interface to an AC power adaptor without the need for a cord between the first power connector and the AC power adaptor. The power cord can further include a connection adaptor, the connection adaptor having a first end configured to mate to the first power connector and a second end configured to mate to a power adaptor.

This application claims priority to U.S. Patent Provisional Application Ser. No. 60/642,859, filed on Jan. 10, 2005, the disclosures of which are herein incorporated by reference in their entirety.

### BACKGROUND OF THE INVENTION

1. Field of the Invention

The present invention relates to power products, and more particularly to a multiple outlet power cord.

2. Description of Related Art

Our contemporary society enjoys numerous electronic devices that help to make our lives more productive, more comfortable and more efficient. Such devices include, for example, notebook computers, personal digital assistants (PDAs), cell phones, computer printers, DVD players, DC players, MP3 players, digital cameras, camcorders, and other electronic devices. With advancements in technology allowing a decrease in size and improved efficiencies in battery life, portability of such items has improved dramatically. In fact, more users than ever can be seen traveling with one or more of the electronic devices listed above.

To enhance the portability, rechargeable batteries, although not required, are often provided. Examples of such rechargeable batteries include, among others, lithium, lithium ion, nickel cadmium (NiCad), and nickel metal hydride (NiMH). Such rechargeable batteries allow a user to operate the electronic device away from an AC power source for some period of time. However, even with a battery source to enhance the portability, an occasional or periodic hookup to an AC power source is typically made to either operate the device directly or to recharge the batteries (or both).

When traveling to certain locations, however, the accessibility to and availability of AC power outlets can be limited. As such, users traveling with multiple electronic devices may find difficulty powering or charging their electronic devices simultaneously.

### SUMMARY OF THE INVENTION

In one embodiment, the present invention is directed toward a multiple outlet power cord, including: a main body having a first power connector; a power cord having first and second ends, the first end attached to the main body and electrically connected to the first power connector; a power plug attached to the second end of the power cord and configured to receive power from a power source; and a circuit breaker disposed in the main body. In one embodiment, the first power connector is shaped so as to directly interface to an AC power adaptor without the need for a cord between the first power connector and the AC power adaptor. The power cord can further include a connection adaptor, the connection adaptor having a first end configured to mate to the first power connector and a second end configured to mate to a power adaptor.

In one embodiment, a power product can include a fixed output power supply having a DC power output electrically connected to an output socket on the main body, which can be implemented for example using a USB socket. A network interface can also be provided to allow the power product to be connected to a network and to provide a network connection to the output socket.

Another embodiment of the invention is an apparatus to provide power to a power adaptor, including means for providing electrical power to a main body; means for mating a main body directly with a male AC power connector on a device; means for connecting the main body to a power source; and a circuit breaker means disposed in the main body; wherein the means for mating is shaped so as to directly interface to an AC power connector on a device without the need for a cord between the first power connector and the AC power connector on the device.

Yet another embodiment of the invention provides a multiple outlet power product that includes: a main body having a plurality of output power connectors; an input power connector electrically connected to the output power connectors; and a circuit breaker disposed in the main body; wherein at least one of the output power connectors is shaped so as to directly interface to an AC power adaptor without the need for a cord between the first power connector and the AC power adaptor. Removable connection adaptors having a first end configured to mate to the output power connector and a second end configured to mate to the AC power adaptor can also be included.

In still a further embodiment, a power product includes a main body having an output power connector configured to mate with an AC power adaptor, an input power connector electrically connected to the output power connectors, and a circuit breaker disposed in the main body. At least one of the output power connectors is shaped so as to directly interface to the AC power adaptor without the need for a cord between the first power connector and the AC power adaptor. The AC power adaptor is integrated into a device to be powered.

In yet a further embodiment, a power product, includes: a body; a power converter disposed within the body and configured to convert an input power signal into an output power signal adapted to power an electronic device; an input power connector electrically connected to the power converter configured to accept the input power signal; an output power connector electrically connected to the power converter and configured to mate with an input power connector of an electronic device; and a network interface in the housing configured to connect with a computer network and to provide a network connection to the electronic device. In one embodiment, the output power connector is shaped so as to directly interface to the AC power adaptor without the need for a cord between the output power connector and the AC power adaptor. In another embodiment, there is a power cord between the power converter and the output power connector. A power cord can also be provided between the power converter and the input power connector. The output power connector can be implemented using a USB socket configured to accept a USB plug from an electronic device, and the network connection can be provided via the USB socket.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating a power cord in accordance with one embodiment of the invention.

FIG. 2 is a diagram illustrating a power cord in accordance with another embodiment of the invention.

FIG. 3 is a diagram illustrating a power cord in accordance with another embodiment of the invention.

FIG. 4 is a diagram illustrating another view of the example power cord illustrated in FIG. 3.

FIG. 5 is a diagram illustrating a power cord in accordance with another embodiment of the invention.

FIG. 6 is a diagram illustrating an electrical schematic of an example circuit implementation of the embodiment of FIG. 5.

FIG. 7 illustrates a top view of a further exemplary embodiment of the present invention.

FIG. 8 illustrates an electrical schematic showing an exemplary electrical circuit implementation of the embodiment shown in FIG. 7.

FIG. 9 illustrates yet another embodiment of the present invention.

FIG. 10 shows an example electrical schematic of a circuit implementation of the embodiment shown in FIG. 9.

### DESCRIPTION OF THE PREFERRED EMBODIMENTS

The present invention is directed to combining the functionality of a multiplicity of AC power cords for powering (i.e., powering directly or recharging or both) portable electronic devices and for allowing connection to a multiplicity of AC adapters for powering portable electronic devices including, among others, notebook and laptop computers, personal digital assistants (PDAs), cell phones, computer printers, DVD players, DC players, MP3 players, digital cameras, camcorders, and battery chargers with a compact, easily transportable unit. Additional embodiments of the present invention can include further features, among others, such as (i) power and ground status indication, (ii) fuses and circuit breakers, (iii) power and power source switching, (iv) AC power line surge suppression, (v) AC power line RF interference filtering, and (vi) DC to AC and AC to DC power conversion. This allows for a single and preferably compact unit with one AC or DC power supply line cord to simultaneously power one or more similar or different electronic devices.

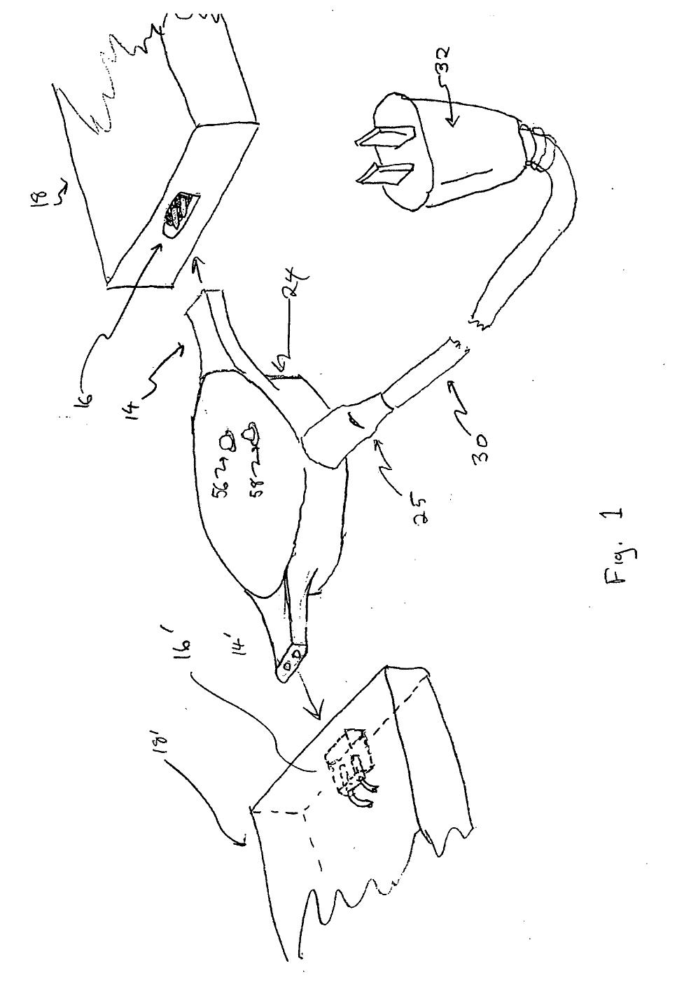

FIG. 1 illustrates a perspective view of one embodiment of the present invention. Referring now to FIG. 1, the illustrated embodiment includes: (i) a main body 24; (ii) an AC power cord 30 terminating in a male AC plug 32; (iii) an optionally included strain relief member 25; (iv) two exemplary status indicators 56 and 58; and (v) two exemplary female AC connectors 14 and 14′ affixed to main body 24 that are capable of mating with male connectors 16 and 16′ on portable electronic devices shown as 18 and 18′, respectively. The main body 24 of this embodiment of the invention can be made of a low conductivity or nonconductive organic polymer such as polyvinyl chloride (PVC), polyacrylonitrile-butadiene-styrene (ABS), polymethylmethacrylate (PMMA), or other suitable housing material that can be formed by molding or machining using techniques well known in the art. It is preferable that the material of main body 24 have suitable insulating properties as would be understood by one of ordinary skill in the art.

Optionally included stress relief member 25 transitions from the main body 24 to a power cord 30. Illustrated in FIG. 1 is a conventional AC power cord 30 that ends in a male plug 32 for a wall outlet. Although a non-grounded version of the AC plug is shown in FIG. 1, a grounded version could also be used.

Portable electronic devices 18 and 18′ contain male AC power input connectors 16 and 16′, respectively, which mate with female AC power supply connectors 14 and 14′, respectively and which in the illustrated embodiment extend from the main body 24. Although illustrated as integrally formed with main body 24, AC power input connectors 16 and 16′ could be implemented as modular type connectors as further described herein in one or more of the alternative embodiments.

Optionally one or more status indicators (two, 56 and 58 are shown here for purposes of illustration) may be included with main body 24, for example, to signal the presence of AC voltage, or for an additional example, in the event that 32 is a grounded plug, to signal the presence of a good ground connection. Other status indicators could also be provided.

Note that in the illustrated embodiment, up to two devices can be simultaneously connected to main body 24, for simultaneous powering from a single AC power cord 30. Main body 24 can alternately be provided with more than two outlets to mate with the same or different types of connectors on portable electronic devices or AC adapters for portable electronic devices.

In this and other embodiments, one or more USB or other like standardized sockets can be provided on main body 24 to allow connection of devices such as, for example, cell phones, PDAs and other devices. Additionally, a fixed output power supply can be included to provide the voltage and current as specified for the standardized connector. For example, a USB socket may have a 5 volt, 500 milliamp feed such that a user's blackberry, cell phone or other device can be plugged in for charging.

Additionally, wireless or wired network capabilities can be included with the housing 24 such that the USB (or other) socket can provide the ability to provide power to as well as a network connection to a peripheral device with the power adaptor acting as a network hub, gateway or other portal. Thus, for example, a printer, scanner, digital camera, PDA or other device can be powered by the adaptor as well as connected to a local or wide area network via the power adaptor. Networking technologies are known to those of skill in the art and can include technologies such as wired Ethernet, IEEE 802.11, HPNA (Home Phoneline Networking Alliance), Bluetooth, and Power-Line Networking, just to name a few.

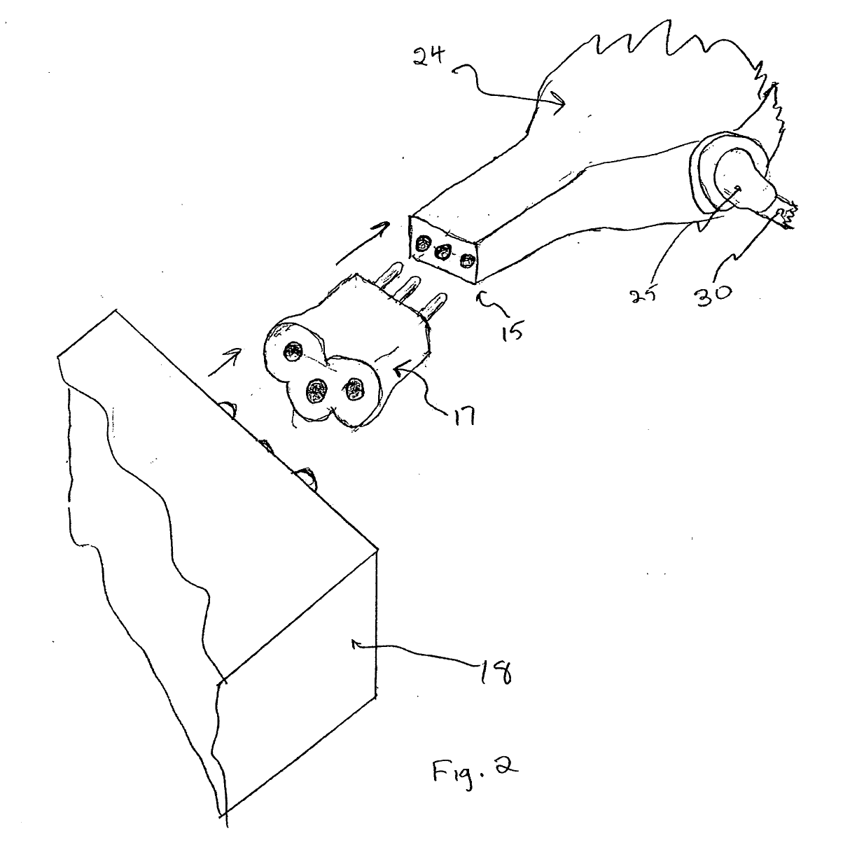

FIG. 2 shows a perspective view of another embodiment of the present invention in which an intermediate AC outlet 15 on the main body 24 is designed to mate with a connection adapter 17 that provides a proper power connection to AC adapter 18. Connection adapters such as 17 may be customized to accommodate a variety of AC power interfaces, and easily swapped with one another into intermediate AC outlets such as 15 to accommodate different types of devices 18 to be powered. This is advantageous in that the connection adapters can be made small, and easy to carry compared with a single, required main body 24. This permits a user the flexibility to optionally accommodate an array of portable devices having the same or different male AC power connectors with a single main body, while minimizing weight, bulk, and expense. This also allows for economies of scale in manufacturing and inventory handling by allowing, for example, one type of ‘generic’ main body and power cord unit to be manufactured, distributed, and stocked, along with a multiplicity of modular connection adapters 17.

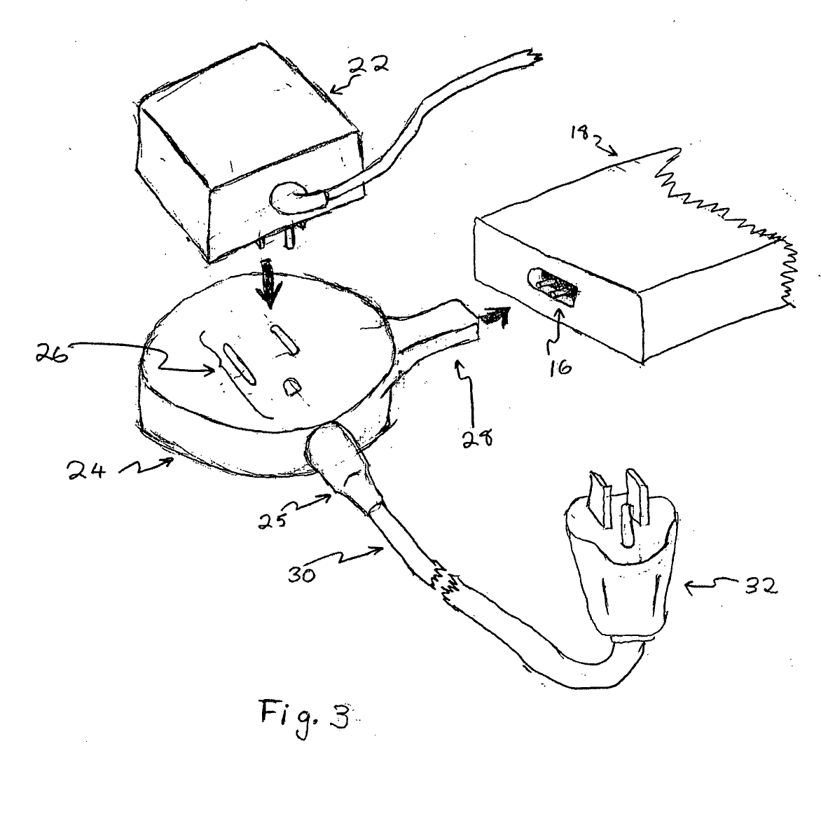

FIG. 3 illustrates a perspective view of another embodiment of the invention and its use. In this embodiment main body 24 can include at least one female AC outlet 28 that can mate with a corresponding male AC power connector 16 on a device 18. Additionally, main body 24 can include at least one standard AC wall outlet configuration 26. This is useful, for example, for use with a “wall wart” type AC adapter 22 that is configured to use directly with a wall outlet. As discussed above, an optional strain relief member 25, an AC cord 30 and an AC male grounded plug 32 for a wall outlet are also shown.

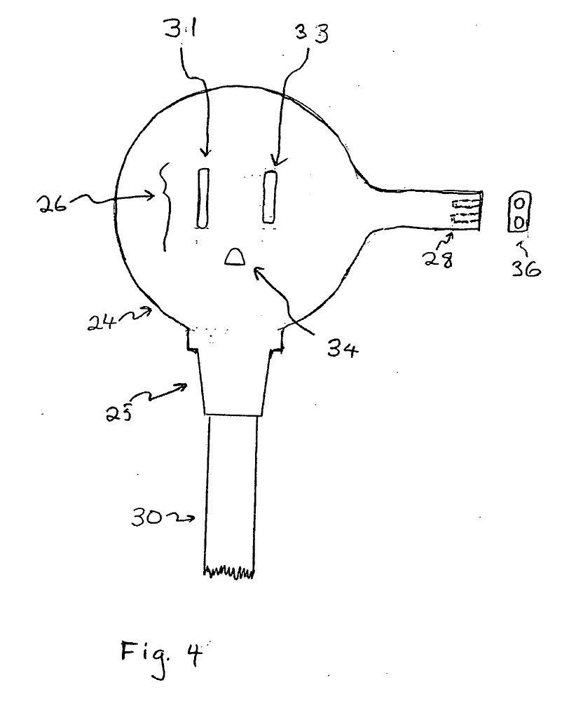

FIG. 4 illustrates a top view of the embodiment shown in perspective view in FIG. 3. 36 is and end-on view of AC outlet 28. Reference numbers for the other drawing elements in FIG. 4 are the same as those used in FIG. 3, with the exception that the prongs of the standard female AC grounded outlet 26 are individually numbered. Slot 31 is referred to as the “neutral” connection, slot 33 is referred to as the “hot” connection, and slot 34 is referred to as the “ground” connection. Normally, power is supplied by an AC voltage difference between the hot and neutral connections and there is no voltage difference between the neutral connection and ground. In this configuration, the ground connection is provided for safety purposes in the event that the neutral connection is interrupted.

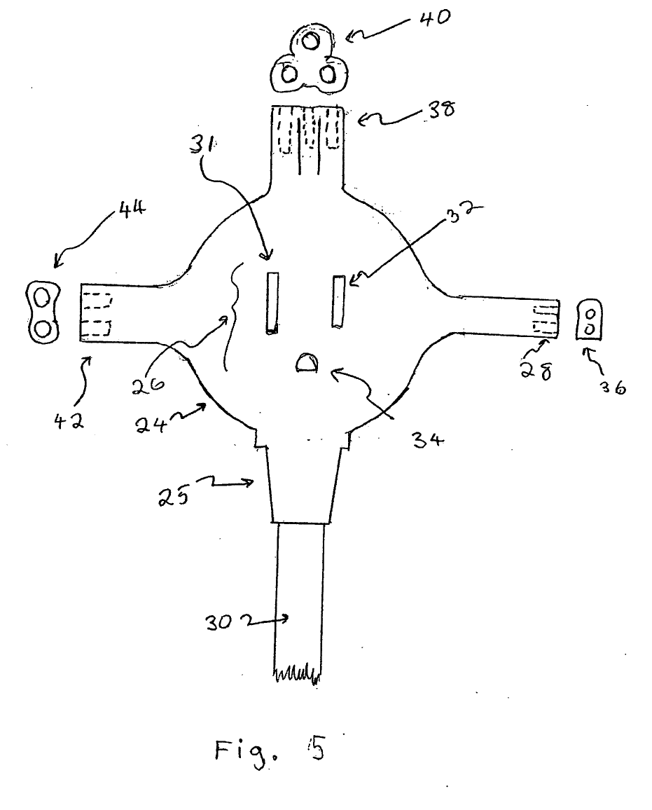

FIG. 5 illustrates a top view of another exemplary embodiment of the present invention, showing for example: (i) main body 24; (ii) AC power cord 30; optionally included strain relief member 25; (iii) AC grounded female outlet 26 consisting of receptacles for neutral 31, hot 32, and ground 34 prongs or pins; (iv) AC outlet 42 of the two-wire, non-polarized type; (v) AC outlet 28 of the two-wire, polarized type; and (vi) AC outlet 38 of the three-wire, grounded type. In this embodiment, the main body 24 is provisioned with three different types of female AC power supply connectors that are compatible with three different types of AC male power connectors: two-wire, non polarized 42 (shown end-on in 44), three-wire grounded 38 (shown end-on in 40), and two-wire, polarized 28 (shown end-on in 36). Additionally a conventional female grounded wall outlet configuration 26 is included. Optional status indicators may also be included on a face of the main body, although this is not illustrated in FIG. 5. In the exemplary embodiment of FIG. 5, main body 24 can be used to simultaneously power up two four different devices with corresponding, compatible male connectors. Alternately, main body 24 can flexibly provide connection to up to four different types of devices requiring four different types of compatible AC connectors.

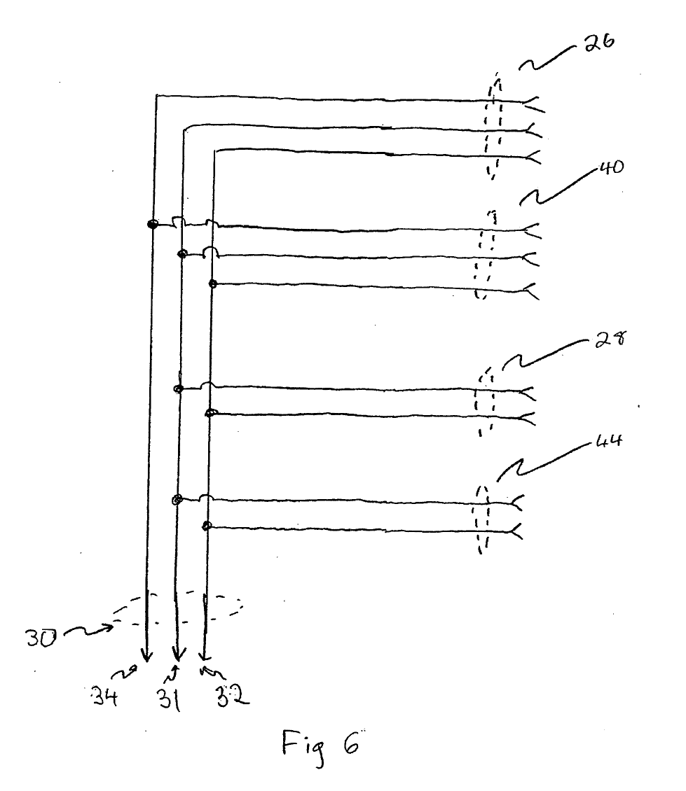

FIG. 6 shows an electrical schematic of an example circuit implementation of the embodiment of FIG. 5. Drawing elements having the same reference numbers in FIGS. 5 and 6 identify corresponding elements in both Figures. In this exemplary embodiment, a parallel power connection is provided with no additional power conditioning or status indication features. Status indicators could be included, for example, by connecting a power indicator between lines 31 and 32, and a ground indicator betweens lines 32 and 34.

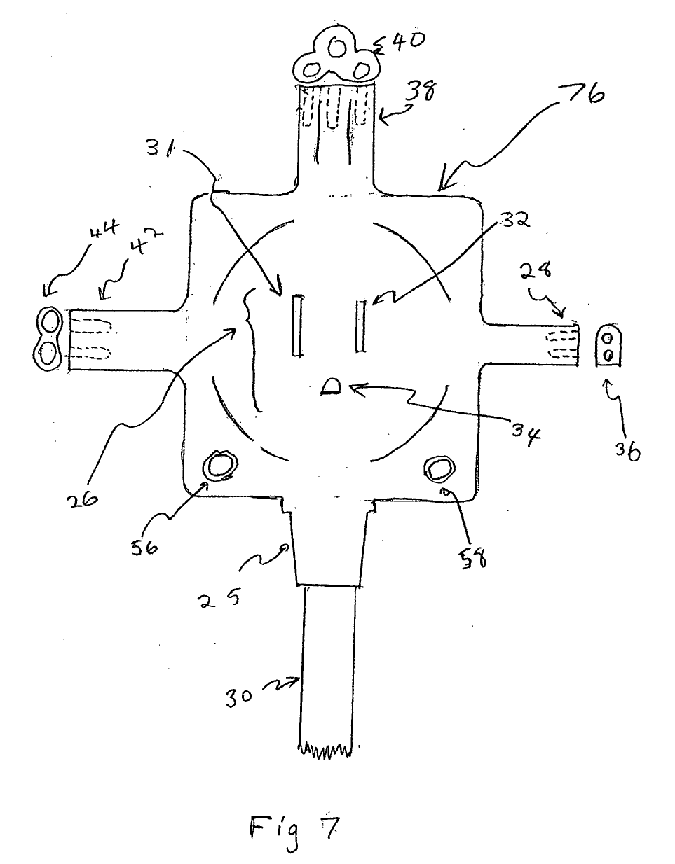

FIG. 7 shows a top view of a further exemplary embodiment of the present invention. As in the embodiment of FIG. 5, the main body 76 is provisioned with three different types of preferably female connector configurations each of which differs from the others and is compatible with one of three different types of male AC power source connectors: two-wire, non polarized 42 (shown end-on in 44), three-wire grounded 38 (shown end-on in 40), and two-wire, polarized 28 (shown end-On in 36). A conventional female grounded wall outlet configuration 26 is also included. Additionally, status indicators 56 and 58 can be included, for example, as power and ground indicators.

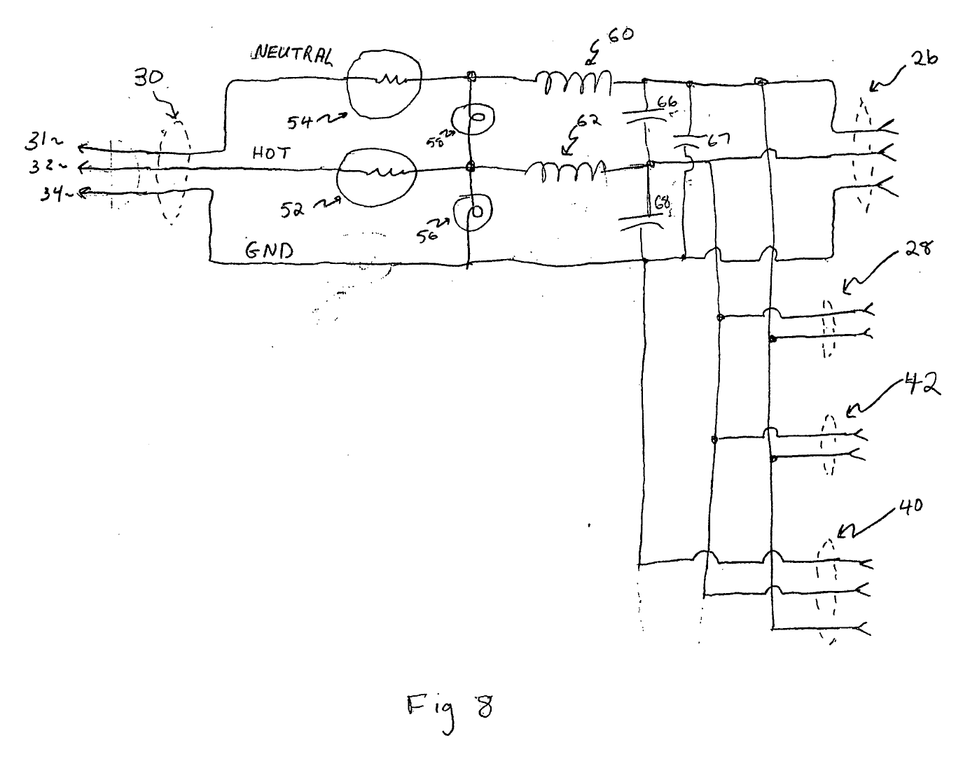

FIG. 8 is an electrical schematic showing an exemplary electrical circuit implementation of the embodiment shown in FIG. 7. Drawing elements having the same reference numbers in FIGS. 7 and 8 identify corresponding elements in both Figures. In the embodiment shown in FIGS. 7 and 8, surge protection is provided using varistor components 52 and 54 in series with the hot and neutral lines, respectively, although other surge protection techniques can be implemented. Varistors are well known in the art. They are two-terminal devices that respond to an increasing current through them with an increasing resistance to that current. Thus they are useful in suppressing power surges from a power main by selectively attenuating surges of current. If the current surge is too great, the varistor reliably fails in an open-circuit mode, protecting the attached equipment. Failed varistors are not typically intended to be user-replaceable, and in one embodiment the main body can be implemented as a replaceable item in the event of varistor failure. As such, in this implementation it may be desirable to manufacture main body 24 with low replacement cost in mind.

Status indicators such as 56 and 58, for example, may optionally be included. Optional status indicator 58 is actuated when AC power is present at mains 30 and the varistors 52 and 54 have not open-circuited. Optional status indicator 56 is actuated when AC power is present at mains 30, varistors 52 and 54 have not open circuited, and the ground is present resulting in a current flow between “hot” line 32 and ground line 34. Indicator lamps may be used as status indicators, such as any of a variety of lamps compatible with AC line voltages (in the U.S. typically 110V RMS), including, but not limited to: (i) gas discharge lamps such as neon lamps; (ii) incandescent lamps with or without a series dropping resistor; and (iii) light emitting diode lamps with a series dropping resistor. Alternately, status indication may be provided through different means such as LCDs or electromechanical visual or audio annunciators as is well known in the art.

Although varistors 52 and 54 provide attenuation to low speed voltage transients on the AC mains line 30, series inductors 60 and 62, in combination with capacitors 66, 67, and 68 function as low pass filters that can be included to additionally provide attenuation to high speed voltage or current transients and radio frequency interference that may be present on the AC mains 31. Such high speed voltage transients and RF interference could potentially adversely impact the operation of the attached equipment. Alternate low pass filter circuit topologies and devices may also be implemented.

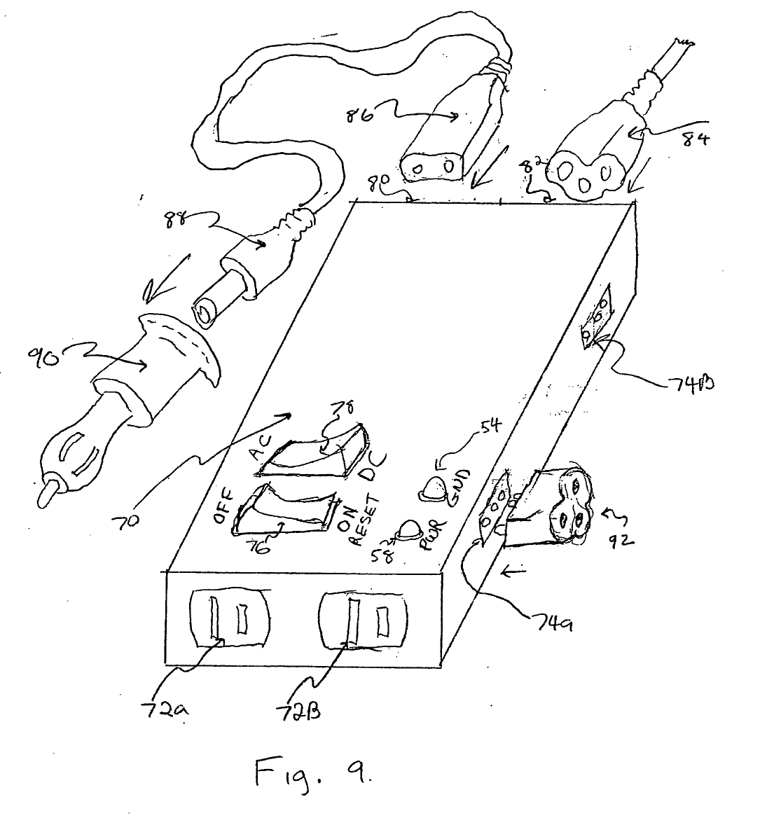

FIG. 9 illustrates yet another embodiment of the present invention, including in this example: (i) main body 70; (ii) AC power outlets 72a and 72b; (iii) intermediate female AC outlets 74a and 74b (intermediate female AC outlets 74c and 74d are symmetrically disposed to 74a and 74b on the hidden left side of main body 70 and therefore not shown); (iv) status indicators for power 58 and ground 54; (v) on/off/circuit breaker reset switch 76; (vi) AC/DC power source selector switch 78; (vi) a male AC power connector 82, capable of mating with female AC power supply cord 84; (vii) a 12V (nominal) male, polarized DC power input connector 80, capable of mating with DC power supply cord connector 86; (viii) DC airline power plug 88; and (ix) airline power plug to automotive cigarette lighter adapter 90. This embodiment potentially provides additional versatility over the previous embodiments.

Main body 70 can allow for the simultaneous provision of AC power to multiple devices with different types of connectors (in this illustration female outlets 72a and 72b for standard AC wall plugs, and female intermediate connectors 74a, 74b, 74c, and 74d in conjunction with pin adapters such as 92, as discussed above, for specific portable equipment), using either a mains AC power supply (male connector 82 mating with female AC line cord connector 84), an airline DC power source (dc female connector 86 mating with female connector 80, and connected through a cable to airline DC connector 88), or an automotive electrical system power source (automotive pin adapter 90 connected to airline DC connector 88) as a power source. Switch 76 provides main power on and off control, as well as circuit breaker resetting. Switch 78 switches the input power source from AC to DC.

In this and other embodiments, one or more USB or other like standardized sockets can be provided on main body 70 to allow connection of other devices including cell phones, PDAs and other devices as examples. Additionally, a fixed output power supply can be provided (as a tap off from the main power converter or as a dedicated power supply) to provide the voltage and current as specified for the standardized connector. For example, a USB socket may have a 5 volt, 500 milliamp feed such that a user's blackberry, cell phone or other device can be plugged in for charging.

Additionally, wireless or wired network capabilities can be included with the power adaptor such that the USB (or other) socket can provide the ability to provide power to as well as a network connection to a peripheral device with the power adaptor acting as a network hub, gateway or other portal. Thus, for example, a printer, scanner, digital camera, PDA or other device can be powered by the adaptor as well as connected to a local or wide area network via the power adaptor. Networking technologies are known to those of skill in the art and can include technologies such as wired Ethernet, IEEE 802.11, HPNA (Home Phoneline Networking Alliance), Bluetooth, and Power-Line Networking, just to name a few.

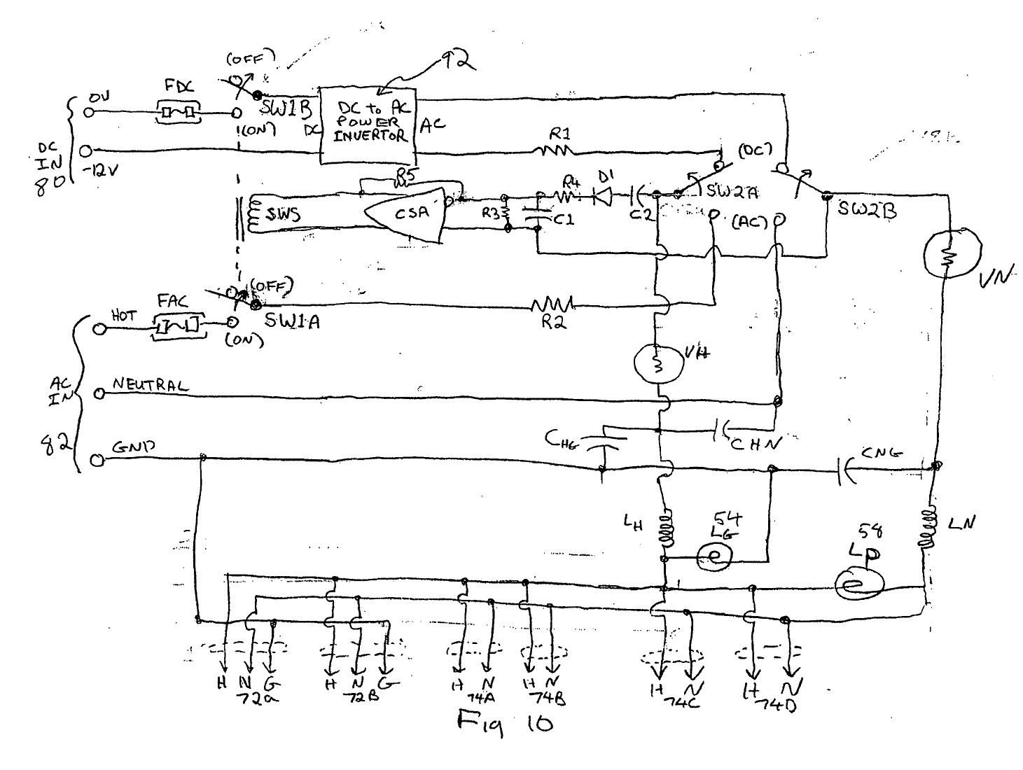

FIG. 10 shows an electrical schematic of a circuit implementation of the embodiment shown in FIG. 9. Drawing elements having the same reference numbers in FIGS. 9 and 10 identify corresponding elements in both Figures. In addition to the optional inclusion of varistors, capacitors, and inductors for slow and fast transient and RF interference noise suppression, and the status indicators 54 and 58, all as discussed above in relation to FIG. 8, FIG. 10 includes further optional circuit protection in the form of fuses FAC and FDC, and an electronic circuit breaker circuit. Additionally, FIG. 10 optionally provides an DC to AC power inverter, many types of which are well known in the art and commercially available. Solenoid, or manually actuated, ganged switches SW1A and SW1B in FIG. 10 make up “on/reset/off” switch 76 in FIG. 9. Ganged switches SW2A and SW2B in FIG. 10 make up the “AC/DC” switch in FIG. 9.

In FIG. 10, the electronic circuit breaker can operate by sensing an integrated, rectified, AC coupled voltage (using C2, D1, R4, C1, and R3) derived, switchably (using SW2A and SW2B) using the current times resistance voltage drops across resistors R1 or R2 on the “hot” lines. In general, R1 and R2 may have different values to set the circuit breaker threshold at different “hot” line trip current levels for the AC and DC supply modes. This is useful in situations where the DC to AC power inverter 92 may have a lower current limit than the AC mains supply 82. When the voltage drop across either R1 or R2 exceeds a specified level, the operational amplifier CSA, in conjunction with feedback resistor R5, operates solenoid SWS to actuate ganged switches SW1A and SW1B to transition to the “Off” position, where they stay until manually reset.

Several embodiments of the present invention have been described above. In some cases the specific features were arbitrarily selected for purposes of illustration in a given embodiment. However, it is understood that these various embodiments and examples are exemplary only and should not serve to limit the scope of the invention. It is also readily understood by those of ordinary skill in the art how to design and implement the disclosed embodiments using alternative architectures, processes, functionality, structures, and implementations. Additionally, the inclusion of features from any one or more of the above embodiments in any one or more of the other above embodiments, or the elimination of some features from an embodiment, will be readily apparent to one of ordinary skill in the art after reading this description. In sum, after reading this description, various modifications of and alternatives to the preferred embodiments described above can be implemented by those of ordinary skill in the art, without undue experimentation. These various modifications and alternatives are contemplated to be within the spirit and scope of the invention. For example without limiting the generality of the foregoing, the circuit schematics of FIGS. 6, 8, and 10 are meant to be exemplary; one of ordinary skill in the art could readily identify many viable alternatives for surge suppression, RF noise filtering, status indication, circuit breaker function, and status sensing and indication after reading the description contained herein.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives like “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise.

What is claimed is:

1. A multiple outlet power cord, comprising:
a main body having a first power connector;
a power cord having first and second ends, the first end attached to the main body and electrically connected to the first power connector;
a power plug attached to the second end of the power cord and configured to receive power from a power source; and
a circuit breaker disposed in the main body;
wherein the first power connector is shaped so as to directly interface to an AC power adaptor without the need for a cord between the first power connector and the AC power adaptor.

2. The power cord of claim 1, further comprising a connection adaptor, the connection adaptor having a first end configured to mate to the first power connector and a second end configured to mate to a power adaptor.

3. The power cord of claim 1, further comprising a female AC connector on the housing configured to mate to a standard AC male plug.

4. The power cord of claim 1, further comprising a status indicator to indicate the presence of power from the power source.

5. The power cord of claim 1, further comprising a status indicator to indicate the presence of a ground connection to the power source.

6. The power cord of claim 1, wherein the first power connector is a female AC connector.

7. The power cord of claim 1, wherein the circuit breaker is a resettable circuit breaker.

8. The power cord of claim 1, further comprising a DC power input connector in the housing.

9. The power cord of claim 1, further comprising a DC to AC power inverter disposed in the housing.

10. The power cord of claim 1, further comprising an AC/DC power source selector control.

11. The power cord of claim 1, further comprising a second power cord coupled to the main body via a power connector.

12. The power cord of claim 1, further comprising a fixed output power supply having a DC power output electrically connected to an output socket on the main body.

13. The power cord of claim 12, wherein the output socket is a USB socket.

14. The power cord of claim 12, further comprising a network interface configured to provide a network connection to the output socket.

15. An apparatus to provide power to a power adaptor, comprising:
means for providing electrical power to a main body;
means for mating a main body directly with a male AC power connector on a device;
means for connecting the main body to a power source; and
a circuit breaker means disposed in the main body;
wherein the means for mating is shaped so as to directly interface to an AC power connector on a device without the need for a cord between the first power connector and the AC power connector on the device.

16. A multiple outlet power product, comprising:
a main body having a plurality of output power connectors;
an input power connector electrically connected to the output power connectors; and
a circuit breaker disposed in the main body;
wherein at least one of the output power connectors is shaped so as to directly interface to an AC power adaptor without the need for a cord between the first power connector and the AC power adaptor.

17. The power product of claim 16, further comprising a removable connection adaptor, the connection adaptor having a first end configured to mate to the output power connector and a second end configured to mate to the AC power adaptor.

18. A power product, comprising:
a main body having an output power connector configured to mate with an AC power adaptor;
an input power connector electrically connected to the output power connectors; and
a circuit breaker disposed in the main body;
wherein at least one of the output power connectors is shaped so as to directly interface to the AC power adaptor without the need for a cord between the first power connector and the AC power adaptor.

19. The power product of claim 18, wherein the AC power adaptor is integrated into a device to be powered.

20. The power product of claim 18, further comprising a removable connection adaptor, the connection adaptor having a first end configured to mate to the output power connector and a second end configured to mate to the AC power adaptor.

21. The power cord of claim 18, further comprising a fixed output power supply having a DC power output electrically connected to an output socket on the main body.

22. The power cord of claim 21, wherein the output socket is a USB socket.

23. The power cord of claim 21, further comprising a network interface configured to provide a network connection to the output socket.

24. A power product, comprising:
a body;
a power converter disposed within the body and configured to convert an input power signal into an output power signal adapted to power an electronic device;
an input power connector electrically connected to the power converter configured to accept the input power signal;
an output power connector electrically connected to the power converter and configured to mate with an input power connector of an electronic device; and
a network interface in the housing configured to connect with a computer network and to provide a network connection to the electronic device.

25. The power product of claim 24, wherein the output power connector is shaped so as to directly interface to the AC power adaptor without the need for a cord between the first power connector and the AC power adaptor.

26. The power product of claim 24, further comprising a power cord between the power converter and the output power connector.

27. The power product of claim 24, further comprising a power cord between the power converter and the input power connector.

28. The power cord of claim 24, wherein the output power connector is a USB socket configured to accept a USB plug from an electronic device, and wherein the network connection is provided via the USB socket.
